(19) United States
(12) Patent Application Publication
(10) Pub. No.: US 2003/0128856 A1
(43) Pub. Date: Jul. 10, 2003

(54) Digitally programmable gain amplifier

(76) Inventor: Steven E. Boor, Plano, TX (US)

Correspondence Address: THOMAS K. STINE, ESQ., WALLENSTEIN & WAGNER, LTD, 53rd Floor, 311 South Wacker, Chicago, IL, 60606-6622, US

(21) Appl. No.: 10/041,367

(22) Filed: Jan. 8, 2002

(51) Int. Cl. H04R 25/00

(52) U.S. Cl. 381/321; 381/312

(57) ABSTRACT

A hearing aid for converting input acoustical energy into an electrical signal, processing the signal and converting the processed electrical signal into acoustical energy is disclosed. The hearing aid includes a digitally programmable gain amplifier. The digitally programmable gain amplifier comprises circuitry for decoding a digital control input signal (referred to as the serial data input), and based upon the digital control signal it comprises a means for changing the amplifier gain.

### CROSS-REFERENCE TO RELATED APPLICATIONS

None.

### FEDERALLY SPONSORED RESEARCH OR DEVELOPMENT

Not Applicable.

### TECHNICAL FIELD

This invention relates to hearing aids, and more particularly, to a digitally programmable gain amplifier for a hearing aid.

### BACKGROUND OF THE INVENTION:

A hearing aid typically includes a microphone for converting acoustic energy to an electrical signal, electronics for amplifying and otherwise processing the electrical signal, and a receiver for converting the processed electrical signal into acoustic energy.

In hearing aid applications, the human ear cannot easily discern any improvements of signal-to-noise ratios greater than about 55 dB. Thus it is common in low battery voltage analog systems, such as hearing aid applications, that a trade-off is made between optimal noise performance and maximum signal performance. This is especially true in digital hearing aid systems, whereby a fixed gain pre-amplifier is often placed between the microphone output and an analog-to-digital (A/D) converter, so as to minimize the noise contribution of the A/D converter in the overall system.

Hearing aids typically have a fixed minimum noise component, regardless of the amplifier gain. This is referred to as input referred noise. Thus one obtains the best signal-to-noise ratio at maximum gain, because the input referred noise is proportionally less. This is advantageous for low input signal conditions. But for large input signal conditions, maximum gain is not desirable, because it can result in signal clipping. In such cases it is desirable to reduce the gain, while still maintaining the signal-to-noise ration at or above 55 dB.

To improve performance, it would be advantageous in such low battery voltage systems to have the microphone output amplified by a programmable gain amplifier, especially if the programmable gain amplifier was integrated directly into the microphone itself. Under quiet or no input signal conditions, the gain would be maximized, allowing the system noise performance to be optimized. Under moderate to loud input conditions the gain could be reduced, thus optimizing the large signal performance of the system. In digital hearing aid systems, it would be advantageous if the gain setting could be digitally programmable.

### SUMMARY OF THE INVENTION

For a hearing aid for converting input acoustical energy into an electrical signal, processing the signal and converting the processed electrical signal back into acoustical energy, it is an object of the invention to provide a digitally programmable gain amplifier.

In accordance with the invention, the digitally programmable gain amplifier comprises means for decoding a digital control input signal (referred to as the serial data input), and based upon the digital control signal it comprises a means for changing the amplifier gain.

These and other aspects and attributes of the present invention will be discussed with reference to the following drawings and accompanying specification.

### BRIEF DESCRIPTION OF THE DRAWINGS

FIG. 1 is a block diagram illustrating a hearing aid including a digitally programmable gain amplifier, in accordance with the invention.

### DETAILED DESCRIPTION OF THE INVENTION

While this invention is susceptible of embodiment in many different forms, there is shown in the drawing, and will be described herein in detail, a specific embodiment thereof with the understanding that the present disclosure is to be considered as an exemplification of the principles of the invention and is not intended to limit the invention to the specific embodiment illustrated.

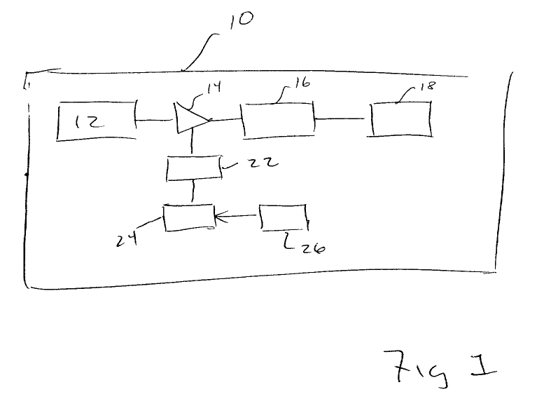

A hearing aid 10, such as for a hearing impaired individual, is illustrated in FIG. 1. The hearing aid 10 includes a microphone 12, a digitally programmable gain amplifier 14, signal processing and amplifying electronics 16 and a receiver 18. The hearing aid further includes an amplifier control 22, a digital decoder 24 and a digital data input module 26.

The microphone 10 converts sound energy into a representative electrical signal. The amplifier 14 amplifies the electrical signal in accordance with a signal from the amplifier control 22. The amplified electrical signal is further processed by the signal processing and amplifying electronics 16, the output of which is converted to sound by the receiver 18. The input of the amplifier control 22 is coupled to the output of the digital decode 24, which is coupled to a digital data input module 26. The digital data input module sends a digital gain control signal to the digital decode 24. The digital data input module 26 may be a controller on the hearing aid for automatically adjusting the gain of the amplifier 14, such as in inverse proportion to the signal level. Alternatively, the digital data input module 26 may be a user selectable digital input. The digital decode 24 sends a control signal to the amplifier control 22, to adjust the gain of the amplifier 14 in fixed, pre-programmed increments.

The amplifier 14 may be contained within the housing of the microphone 12. The amplifier 14 has a variable gain which can be programmed serially via a single external data input pin, so as to minimize the external pin count for the microphone. The digital serial data protocol can be self-clocking, so that no additional clocking signal is needed, in order to eliminate the need for another external microphone pin. The programmable gain feature of the amplifier 14 permits the serial data pin to be used also as a digital volume control input, similar to that on remote controls for televisions and stereos, whereby the gain is either ramped up or down in fixed steps at a relatively slow and controlled rate. The programmable gain feature of the circuit allows the gain to transition directly between any two different gain settings, i.e. without any need to transition to any intermediate gain settings.

The amplifier 14 includes circuitry for decoding a digital control input signal (referred to as the serial data input) for adjusting the gain of the digitally programmable gain amplifier directly between any two gain levels.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A hearing aid for converting input acoustical energy into amplified output acoustical energy, the hearing aid comprising;
a microphone;
a receiver;
a amplifier electrically coupled between the microphone and the receiver; and
means for adjusting the gain of the amplifier between a first pre-programmed gain and a second preprogrammed gain.

2. The hearing aid of claim 1 wherein the adjusting means includes means for adjusting the gain of the amplifier between two or more pre-programmed gains.

3. The hearing aid of claim 1 wherein the adjusting means includes a digital decode to decode a digital gain control signal.

4. The hearing aid of claim 3 wherein the digital decode operates in response to a serial data input.

5. The hearing aid of claim 4 including a controller for sensing the magnitude of the input acoustical energy, and for generating the serial data input in response to the magnitude of the sensed magnitude of the input acoustical energy.

6. The hearing aid of claim 4 including a user operable digital input switch for generating the serial data input.

7. The hearing aid of claim 1 wherein the the microphone includes a housing and the amplifier is contained within the microphone housing.

8. The hearing aid of claim 1 wherein the microphone is an electret microphone.

9. For a hearing aid including a microphone and a receiver, the hearing aid for converting input acoustical energy into amplified output acoustical energy, an amplifier electrically coupled between the microphone and the receiver, the amplifier including means for adjusting the gain of the amplifier between a first pre-programmed gain and a second pre-programmed gain.

10. The amplifier claim 9 wherein the adjusting means includes means for adjusting the gain of the amplifier between two or more pre-programmed gains.

11. The amplifier of claim 9 wherein the adjusting means includes a digital decode to decode a digital gain control signal.

12. The amplifier of claim 11 wherein the digital decode operates in response to a serial data input.

13. The amplifier of claim 9 wherein the microphone includes a housing and the amplifier is contained within the microphone housing.
